(19) United States
(12) Patent Application Publication
(10) Pub. No.: US 2010/0250009 A1
(43) Pub. Date: Sep. 30, 2010

(54) CONTROL OF CONDITIONED ENVIRONMENT BY REMOTE SENSOR

(75) Inventors: Alexander Lifson, Manlius, NY (US); Michael F. Taras, Fayetteville, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/746,432

(22) PCT Filed: Dec. 7, 2007
(86) PCT No.: PCT/US07/86749

§ 371 Date: Jun. 4, 2010

(51) Int. Cl. G05D 23/00

(52) U.S. Cl. 700/278; 236/51

(57) ABSTRACT

A comfort HVAC or refrigeration system includes a remote sensor for sensing an environmental condition within a climate-controlled space and having, an associated transmitter for sending, a wireless signal to a receiver of a controller such that the controller can then responsively modulate the operation of the components of the HVAC or refrigeration system to maintain a desired condition at a specific location or locations within the-climate-controUed'space. The desired condition can be, for instance, temperature, humidity and/or carbon dioxide level.

### TECHNICAL FIELD

This invention relates generally to comfort HVAC (heating, ventilation, air conditioning) and refrigeration systems and, more particularly, to a method and apparatus for maintaining desired parameters, such as temperature and humidity, within a climate-controlled space while using remote wireless sensors.

### BACKGROUND OF THE INVENTION

Heating, ventilation, air conditioning and refrigeration (HVAC&R) systems are designed to maintain predetermined conditions in a space. These conditions are primarily related to a desired temperature range, but other conditions, such as humidity level and carbon dioxide content, for example, may be controlled as well. This is generally accomplished by the use of one or more dedicated sensors positioned within the space.

Currently temperature and/or humidity sensors are installed within the space at fixed secure locations, and/or hard wired to a control that is either located within the space or outside the space. For example, in a building, the sensor may be associated with a thermostat which is typically mounted on the wall, with wiring passing to a control that responsively activates components of the HVAC system such as a furnace and an air conditioner. In a refrigerated enclosure or a container, one or more sensors are located at specific secured locations within the refrigerated container and are hard wired to a control which is normally located outside of the refrigerated space of the container. However, in either case, the location of the sensor is not necessarily the location where the temperature needs to be measured and controlled. For example, in the building, the temperature needs to be controlled in the near vicinity of a person or a number of people who ale the occupants of the climate-controlled environment. In a container, the temperature needs to be controlled in the particular portion of the space in which the cargo resides or within the cargo itself and not at the specific fixed location at which the sensors have been originally installed. These limitations can be overcome by the present invention.

### DISCLOSURE OF THE INVENTION

In accordance with the present invention, a wireless sensor or sensors are selectively positioned within a space to be conditioned or refrigerated and include a transmitter for communicating a sensed environmental condition to a receiver associated with a controller, which responsively actuates components of an HVAC&R system. In this way, the one or more sensors may be selectively positioned to satisfy the comfort or thermal load requirements and provide precise control of environmental conditions at any desired location in an efficient manner. An environmental condition sensor may include, but is not limited to, a temperature sensor, a humidity sensor, a carbon dioxide sensor of a combination thereof.

### BRIEF DESCRIPTION OF THE DRAWINGS

FIG. 1 is a schematic illustration of a sensor and a control in accordance with the present invention.

FIG. 2 is a schematic illustration of a refrigerated enclosure in accordance with the present invention.

FIG. 3 is a schematic illustration of a comfort HVAC system in accordance with the present invention.

### DETAILED DESCRIPTION OF THE INVENTION

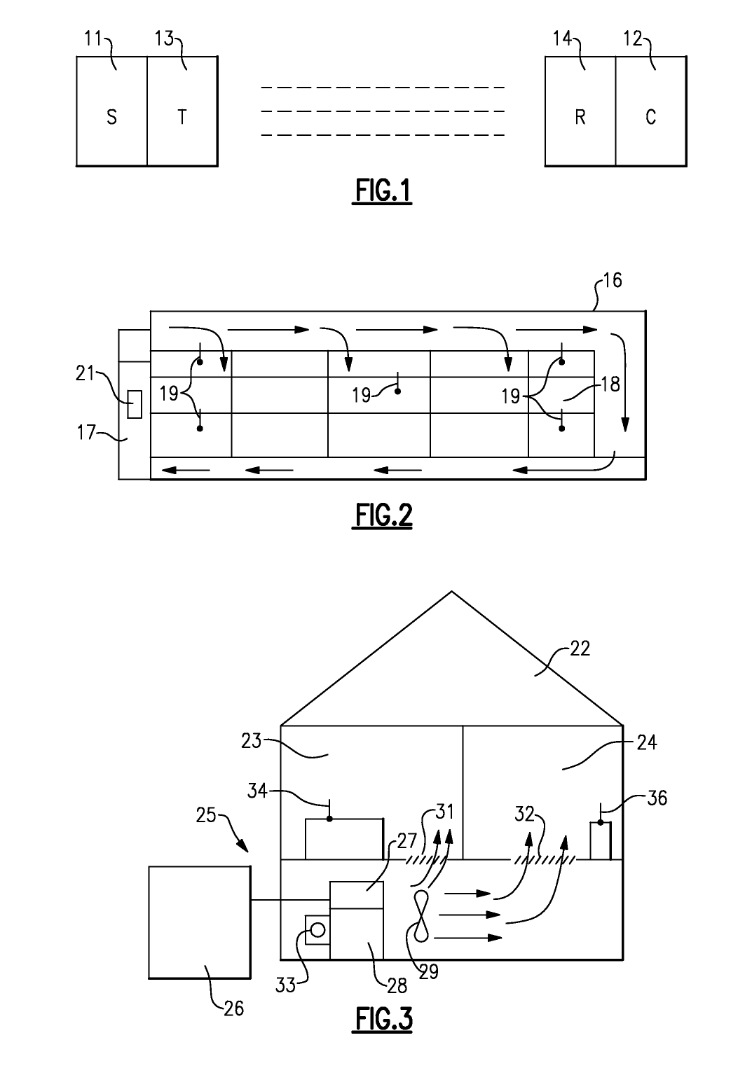

FIG. 1 shows a remote wireless sensor 11 and an associated control 12 in accordance with the present invention. The sensor 11 is designed to sense an environmental condition, such as temperature or humidity, within a space such that the control 12 can responsively operate an HVAC&R system so as to maintain that condition within a predetermined range.

In order to communicate the sensed condition to the control, the sensor 11 is provided with a transmitter 13, and the control 12 is provided with a receiver 14. The transmitter 13 and receiver 14 can be of any wireless type such as, for example, a radio frequency device. Such a wireless arrangement allows for selective placement of one or more sensors within the space to be conditioned as will now be described.

As is seen in FIG. 2, a refrigerated enclosure 16 is provided with an associated refrigeration unit 17. In transport applications, the refrigeration unit 17 is typically mounted on the front end of the refrigerated box 16 and provides conditioned air to the refrigerated enclosure 16 that is typically circulated over the top and through the refrigerated cargo 18, with the air then passing along the floor, and partially along the sides, back to the refrigeration unit 17 to be re-conditioned and re-circulated into The refrigerated enclosure 16. Rather than the one or more sensors being hard wired and positioned at specific secure locations of the refrigerated enclosure 16, a plurality of remote wireless temperature sensors 19 are selectively located within or in the vicinity of the cargo 18, and communicate in a wireless manner with a controller 21 that is typically positioned within the refrigeration unit 17 so as to control the temperature and/or volume of air flowing to the refrigerated enclosure 16, in order to maintain the refrigerated cargo 18 at a temperature within a predetermined range.

In this manner, the refrigerated cargo 18 is Maintained at a predetermined temperature, and over-cooling, as well as insufficient cooling, of the refrigerated cargo 18 is avoided, regardless of the position of the refrigerated cargo 18 within the refrigerated enclosure 16. Furthermore, if the refrigeration unit 17 is capable of providing variable air volume or variable airthrow, the refrigerated cargo 18 can be kept at a sufficiently more uniform temperature in response to the feedback of the remote wireless temperature sensors 19 to the controller 21 of the refrigeration unit 19, in order to avoid potential spoilage or loss of the product quality. Such sensor-controller communication also allows for a more efficient operation and lower energy consumption for the refrigeration unit 17.

It should be understood that that remote wireless temperature sensors 19 may be installed in addition to the primary sensors associated with the refrigeration unit 17 to provide correlation between the air temperature and airflow/airthrow supplied to the refrigerated enclosure 16 and the temperatures within the refrigerated cargo 18, or they may be the primary and only sensors providing feedback to the control 21 of the refrigeration unit 17.

In FIG. 3 there is shown a typical residential building 22 with two climate-controlled spaces such as rooms indicated at 23 and 24. A comfort HVAC system 25 may include an air conditioner or heat pump typically comprising outdoor and indoor units 26 and 27, respectively units and a furnace 28, the latter typically installed to provide heating to the climate-controlled spaces 23 and 24. It should be understood that although the reference is made to a residential building, other construction types, such as, for example, a commercial building, a school or a hospital, are within the scope and can benefit from the invention. The heated or cooled air is circulated by way of an indoor fan 29 through the climate-controlled spaces 23 and/or 24, for instance, by way of respective dampers 31 and 32. The comfort HVAC system 25, including the dampers 31 and 32, is controlled by a control 33 so as to maintain predetermined conditions within the rooms 23 and 24.

Rather than having thermostats hard wired at fixed locations within the room 23 and/or the room 24, wireless sensors 34 and 36 are selectively located within the respective rooms 23 and 24 as shown. It should be understood that the numerals 34 and 36 may also represent different positions of the same wireless sensor. The sensor could, for example, be attached to an individual such as by way of a key chain or the like and, in this case, should be well insulated from the body heat, or could be a movable sensor that an individual can carry from one location to another and place it in his/her vicinity within the associated climate-controlled space. Such an arrangement allows for the control of the comfort parameters such as, for instance, temperature, humidity and carbon dioxide content, at the point of interest, i.e. where one or more persons are congregated (e.g. by way of opening and closing specific air registers or dampers within a climate-controlled space), rather than at a far end of a climate-controlled space (room) where a thermostat might be located or even prevent conditioning of the entire building. It should be understood that a single sensor may control one environmental parameter, and multiple sensors may be used to sense environmental conditions, if desired. On the other hand, a single multi-purpose sensor may control multiple environmental parameters. Further, it may be operable in association with an occupancy system such that, for example, when a person (or persons) bearing the sensor(s) has been within the room 23 for a predetermined period of time, the conditions in that room would be maintained at the desired comfortable level while the conditions in the room 24 might be allowed to rise or fall outside the comfort zone or maintained with less precision. If the person(s) then moves into the room 24 and remains there for a predetermined period of time, the controlled conditions in the two rooms could be reversed. This would occur, for instance, by selective operation of the dampers 31 and 32 as determined by the control 33 in response to the sensed condition at the location of the person(s). In this manner, by providing comfort conditions only at the desired locations, the comfort HVAC system 25 would consume the least amount of power and operate at high efficiency levels.

Although described in terms of use in a refrigerated enclosure such as a refrigerated container and a residential split system, the present invention is equally applicable to similar refrigeration systems, such as truck-trailer systems, wending machines, refrigerated displays and merchandisers, and comfort HVAC systems, such as rooftops and vertically packaged systems.

While the present invention has been particularly shown and described with reference to preferred and modified embodiments as illustrated in the drawings, it will be understood by one skilled in the art that various changes in detail may be made thereto without departing from the spirit and scope of the invention as defined by the claims.

We claim:

1. A comfort HVAC or refrigeration system for providing a conditioned environment in a climate-controlled space comprising:
cooling and/or heating components for providing a conditioned environment in the climate-controlled space;
at least one remote positionable wireless sensor for sensing an environmental condition within the climate-controlled space;
a transmitter associated with said remote positionable wireless sensor for transmitting a signal representative of said sensed environmental condition; and
a control with an associated receiver for receiving said transmitted signal and for controlling said cooling and/or heating components of said comfort HVAC or refrigeration system in response thereto.

2. A comfort HVAC or refrigeration system as set forth in claim 1 wherein said sensed environmental condition is at least one of a temperature condition, a humidity condition and a carbon dioxide content condition.

3. A comfort HVAC or refrigeration system as set forth in claim 1 wherein said at least one remote positionabe sensor comprises a plurality of sensors positioned in different locations within the climate-controlled space.

4. A comfort HVAC or refrigeration system as set forth in claim 1 wherein said at least one remote positionable sensor comprises a primary sensor for said comfort HVAC or refrigeration system.

5. A comfort HVAC or refrigeration system as set forth in claim 1 wherein said at least one remote positionable sensor comprises an auxiliary sensor for said comfort HVAC or refrigeration system.

6. A comfort HVAC or refrigeration system as set forth in claim 1 wherein said at least one remote positionable sensor comprises a multi-purpose sensor to sense multiple environmental parameters associated with said environmental condition in the climate-controlled space.

7. A comfort HVAC or refrigeration system as set forth in claim 1 wherein said transmitter and said receiver communicate by way of radio frequency signals.

8. A comfort HVAC or refrigeration system as set forth in claim 1 wherein said cooling and/or heating components comprise a comfort system which includes at least one of air conditioner, a heat pump and a furnace.

9. A comfort system as set forth in claim 8 wherein at least one remote positionable wireless sensor is adapted to be associated with an individual or with a group of individuals.

10. A comfort system as set forth in claim 9 wherein at least one remote positionable wireless sensor is adapted to be attached to an individual.

11. A comfort system as set forth in claim 8 wherein said control communicating with at least one remote positionable wireless sensor is also in communication with at least one occupancy sensor positioned within the building.

12. A comfort HVAC or refrigeration system as set forth in claim 1 wherein said cooling and/or heating components comprise a refrigeration system for providing refrigerated air to a cargo space.

13. A refrigeration system as set forth in claim 12 wherein said at least one remote positionable wireless sensor is placed within the refrigerated cargo or in the proximity of the refrigerated cargo.

14. A refrigeration system asset forth in claim 12 wherein at least one of air temperature, airflow and airthrow is controlled in response to the sensed temperature received from said at least one remote positionable wireless sensor.

15. A refrigeration system as set forth in claim 12 wherein at least one remote positionable wireless sensor is a plurality of sensors to sense at least one of the temperatures and the temperature differences within the refrigerated cargo or in the proximity of the refrigerated cargo.

16. A method of conditioning an environment of a climate-controlled space, comprising the steps of:
providing cooling and/or heating components of a comfort HVAC or refrigeration system for delivering conditioned air to the climate-controlled space;
locating at least one remote positionable wireless sensor and an associated transmitter within the climate-controlled space;
with the remote positionable wireless sensor, sensing an environmental condition within the climate-controlled space and transmitting a wireless signal representative thereof; and
receiving the wireless signal and responsively controlling said cooling and/or heating components of said comfort HVAC or refrigeration system to maintain a desired environmental condition in the climate-controlled space.

17. A method as set forth in claim 16 wherein said sensed environmental condition is at least one of a temperature condition, a humidity condition and a carbon dioxide content condition.

18. A method as set forth in claim 16 wherein said at least one remote positionable sensor comprises a plurality of sensors positioned in different locations within the climate-controlled space.

19. A method as set forth in claim 16 wherein said cooling and/or heating components comprise a comfort system which includes at least one of an air conditioner, a heat pump and a furnace.

20. A method as set forth in claim 19 wherein at least one remote positionable wireless sensor is adapted to be associated with an individual or with a group of individuals.

21. A method asset forth in claim 19 wherein said control communicating with at least one remote positionable wireless sensor is also in communication with at least one occupancy sensor positioned within the building.

22. A method as set forth in claim 16 wherein said cooling and/or heating components comprise a refrigeration system for providing refrigerated air to a cargo space.

23. A method as set forth in claim 22 wherein said at least one remote positionable wireless sensor is placed within the refrigerated cargo or in the proximity of the refrigerated cargo.

24. A method as set forth in claim 22 wherein at least one of air temperature, airflow and airthrow is controlled in response to the sensed temperature received from said at least one remote positionable wireless sensor.

25. A method as set forth in claim 22, wherein said at least one remote positionable wireless sensor is a plurality of sensors to sense at least one of the temperatures and the temperature differences within the refrigerated cargo or in the proximity of the refrigerated cargo.
